(19) United States
(12) Patent Application Publication
(10) Pub. No.: US 2024/0132075 A1
(43) Pub. Date: Apr. 25, 2024

(54) VEHICLE CONTROL DEVICE, STORAGE MEDIUM STORING COMPUTER PROGRAM FOR CONTROLLING VEHICLE AND METHOD FOR CONTROLLING VEHICLE

(71) Applicant: TOYOTA JIDOSHA KABUSHIKI KAISHA, Toyota-shi Aichi-ken (JP)

(72) Inventors: Ryosuke Hata, Arakawa-ku Tokyo-to (JP); Wataru Kawashima, Nisshin-shi Aichi-ken (JP)

(73) Assignee: TOYOTA JIDOSHA KABUSHIKI KAISHA, Toyota-shi Aichi-ken (JP)

(21) Appl. No.: 18/378,189

(22) Filed: Oct. 9, 2023

(30) Foreign Application Priority Data
Oct. 19, 2022 (JP) 2022-168349

(51) Int. Cl. B60W 30/18; B60W 40/02

(52) U.S. Cl. CPC B60W 30/18163; B60W 40/02; B60W 2420/42; B60W 2420/54; B60W 2554/801

(57) ABSTRACT

A vehicle control device has a processor configured to estimate a direction of a source of a warning sound generated by another vehicle relative to the host vehicle based on an acoustic signal acquired by an acoustical sensor, and decide to drive the host vehicle in a direction perpendicular to a current traveling direction of the host vehicle and away from the source of the warning sound, when the direction of the source of the warning sound relative to the host vehicle is estimated.

### CROSS-REFERENCE TO RELATED APPLICATION

This application claims priority to Japanese Patent Application No. 2022-168349 filed on Oct. 20, 2022, the entire contents of which are herein incorporated by reference.

### FIELD

The present disclosure relates to a vehicle control device, a storage medium storing a computer program for controlling a vehicle, and a method for controlling a vehicle.

### BACKGROUND

An automatic control system mounted on a vehicle has, for example, an automatic driving mode in which the automatic control system is the primarily controller of the operation of the vehicle, and a manual driving mode in which the driver is the primarily controller of the operation of the vehicle (see Japanese Unexamined Patent Publication JP 2019-167116 JP, for example).

### SUMMARY

In the automatic driving mode, the automatic control system generates a driving plan of the vehicle while detecting the surrounding environment of the vehicle using sensors such as an image sensor or a LiDAR sensor, etc. mounted on the vehicle.

When the position of another vehicle relative to a host vehicle is in a position where it is difficult to detect another vehicle for the sensor (blind spot), the sensor may not be able to detect another vehicle accurately. For example, the right rear and left rear of the host vehicle may be a position that is difficult to detect another vehicle for the sensor.

Thus, if the sensor used to generate the driving plan fails to accurately detect the surrounding environment of the host vehicle, a safe driving plan of the host vehicle can not be generated. Therefore, another vehicle and the host vehicle may close to each.

Therefore, even when a sensor used to generate the driving plan such as an imaging sensor or a LiDAR sensor cannot accurately detect the surrounding environment of the host vehicle, it is required to safely drive the host vehicle.

For example, there is an acoustical sensor to detect ambient sounds. The sound has a characteristic (diffraction) that travels around even though there is an obstacle. Therefore, the acoustical sensor can detect the sound emitted by another vehicle no matter what the position another vehicle. The acoustical sensor is usually not used to generate a driving plan for the vehicle.

Accordingly, it is an object of the present disclosure to provide a vehicle control device which is capable of driving the host vehicle so as to avoid the host vehicle approaching another vehicle when a warning sound of another vehicle is detected.
(1) According to one embodiment, the present disclosure provides a vehicle control device. The vehicle control device has a processor configured to estimate a direction of a source of a warning sound generated by another vehicle relative to the host vehicle based on an acoustic signal acquired by an acoustical sensor, and decide to drive the host vehicle in a direction perpendicular to a current traveling direction of the host vehicle and away from the source of the warning sound, when the direction of the source of the warning sound relative to the host vehicle is estimated.
(2) In the vehicle control device of embodiment (1), the processor is further configured to determine whether the reliability of detecting an environment around the host vehicle by another sensor other than the acoustical sensor is at or below a predetermined reference reliability, and decide to drive the host vehicle in the direction perpendicular to the current traveling direction of the host vehicle and away from the source of the warning sound, when the reliability is at or below the predetermined reference reliability and the direction of the source of the warning sound relative to the host vehicle is estimated.
(3) In the vehicle control device of embodiment (1) or (2), the processor is further configured to cause the host vehicle to travel back to the travelling lane when the host vehicle is starting to move from the travelling lane to the adjacent lane and the direction of the source of the warning sound relative to the host vehicle coincides with the direction of the moving direction of the host vehicle.
(4) In the vehicle control device of any of embodiments (1) to (3), the processor is further configured to decide to drive the host vehicle in the central of the traveling lane in which the host vehicle is traveling, when the direction of the source of the warning sound relative to the host vehicle is not estimated, and decide to drive the host vehicle off the central of the traveling lane in which the host vehicle is traveling on the opposite side from the direction of the source of the warning sound relative to the host vehicle.
(5) According to another embodiment there is provided a computer-readable, non-transitory storage medium which stores a computer program for controlling vehicle. The computer program for controlling vehicle includes estimating a direction of a source of a warning sound generated by another vehicle relative to the host vehicle based on an acoustic signal acquired by an acoustical sensor; and deciding to drive the host vehicle in a direction perpendicular to a current traveling direction of the host vehicle and away from the source of the warning sound, when the direction of the warning sound relative to the host vehicle is estimated.
(6) According to yet another embodiment there is provided a method for controlling vehicle. The method for controlling vehicle includes estimating a direction of a source of a warning sound generated by another vehicle relative to the host vehicle based on an acoustic signal acquired by an acoustical sensor; and deciding to drive the host vehicle in a direction perpendicular to a current traveling direction of the host vehicle and away from the source of the warning sound, when the direction of the warning sound relative to the host vehicle is estimated.

The vehicle control device of this disclosure can move the host vehicle so as to avoid the host vehicle approaching another vehicle when a warning sound of another vehicle is detected.

The object and advantages of the present disclosure will be realized and attained by the elements and combinations particularly indicated in the claims. It is to be understood that both the foregoing general description and the following detailed description are exemplary and explanatory, and are not restrictive of the present disclosure as claimed.

### BRIEF DESCRIPTION OF DRAWINGS

FIG. 1A is a diagram illustrating in overview an operation of a drive planning device of the present embodiment and showing a situation in which another vehicle is emitting a warning sound.

FIG. 1B is a diagram illustrating in overview the operation of a drive planning device of the present embodiment and showing a situation in which the host vehicle avoids approaching another vehicle.

FIG. 2 is a general schematic drawing of a vehicle in which a vehicle control system having the drive planning device of the present embodiment is mounted.

FIG. 3 is an example of an operation flow chart for vehicle control processing for the drive planning device according to the present embodiment.

FIG. 4A is a diagram illustrating an exemplary vehicle control processing of the drive planning device of the present embodiment (Part 1).

FIG. 4B is a diagram illustrating an exemplary vehicle control processing of the drive planning device of the present embodiment (Part 1).

FIG. 5A is a diagram illustrating an exemplary vehicle control processing of the drive planning device of the present embodiment (Part 2).

FIG. 5B is a diagram illustrating an exemplary vehicle control processing of the drive planning device of the present embodiment (Part 2).

FIG. 6A is a diagram illustrating an exemplary vehicle control processing of the drive planning device of the present embodiment (Part 3).

FIG. 6B is a diagram illustrating an exemplary vehicle control processing of the drive planning device of the present embodiment (Part 3).

FIG. 7A is a diagram illustrating an exemplary vehicle control processing of the drive planning device of the present embodiment (Part 4).

FIG. 7B is a diagram illustrating an exemplary vehicle control processing of the drive planning device of the present embodiment (Part 4).

FIG. 8 is another example of an operation flow chart for vehicle control processing for the drive planning device according to the present embodiment.

### DESCRIPTION OF EMBODIMENTS

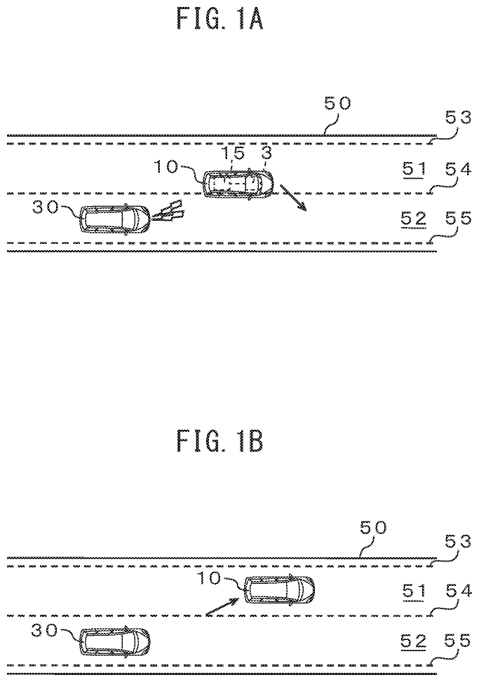

FIG. 1A and FIG. 1B are diagrams illustrating in overview the operation of a drive planning device 15 of the present embodiment. FIG. 1A shows a situation in which another vehicle emitting a warning sound. FIG. 1B shows a situation in which the host vehicle avoids approaching another vehicle.

The operation of the drive planning device 15 disclosed herein will now be described in overview with reference to FIG. 1A and FIG. 1B. The drive planning device 15 is an example of the vehicle control device.

As shown in FIG. 1A, the vehicle 10 is traveling on a traffic lane 51 of a road 50 having traffic lanes 51, 52. The traffic lane 51 is divided by a lane marking line 53 and a lane marking line 54. The traffic lane 52 is divided by the lane marking line 54 and a lane marking line 55. The traffic lane 51 and traffic lane 52 are divided by the lane marking line (lane boundary line) 54.

The vehicle 10 has the drive planning device 15. The drive planning device 15 uses sensors, such as cameras, mounted on the vehicle 10 to generate a driving plan of the vehicle 10 while detecting the environment (road features such as the lane marking lines and other vehicles, etc.) surrounding the vehicle 10. The driving plan is represented as a combination of a target location of the vehicle 10 and a target vehicle speed at the target location, at each time from the current time until the predetermined time.

As shown in FIG. 1A, a vehicle 30 traveling in the traffic lane 52 is approaching the vehicle 10 from the right rear of the vehicle 10. However, the vehicle 30 is not detected by the vehicle 10, since the position of the vehicle 30 relative to the vehicle 10 is in the blind spot of the sensor mounted on the vehicle 10. The drive planning device 15 generates a driving plan in which the vehicle 10 moves from the traffic lane 51 to the adjacent traffic lane 52. The vehicle 10 then starts moving from the traffic lane 51 to the adjacent traffic lane 52.

As shown in FIG. 1A, the vehicle 30 emitted a warning sound to the vehicle 10 that is about to move in front of the vehicle 30. The drive planning device 15 of the vehicle 10 estimates a direction of a source of the warning sound generated by the vehicle 30 relative to the vehicle 10 based on an acoustic signal acquired from an acoustical sensor 3.

For example, the acoustical sensor 3 inputs the left or right sounds relative to the traveling direction of the vehicle 10 to generate the left and right acoustic signal, respectively. The drive planning device 15 estimates the direction of the source of the warning sound whether the left or right relative to the traveling direction of the vehicle 10, based on the acoustic signals acquired by the acoustical sensor 3, when the warning sound emitted by the vehicle 30 is detected.

In the embodiment shown in FIG. 1A, the drive planning device 15 estimates that the source of the warning sound of the vehicle 30 is on the left relative to the traveling direction of the vehicle 10. The drive planning device 15 decides to move the vehicle 10 away from the source of the warning sound, based on the direction of the source of the warning sound.

As shown in FIG. 1B, the vehicle 10 cancels the lane change and returns to the traffic lane 51 in which the vehicle 10 has been traveling until then. The vehicle 30 travels along the traffic lane 52 without approaching the vehicle 10 too closely and passes the vehicle 10.

As described above, the drive planning device 15 can move the vehicle 10 so as to avoid the vehicle 10 approaching the vehicle 30 when the warning sound of the vehicle 30 is detected. This allows the vehicle 10 to travel safely, even when a sensor used to generate the driving plan cannot accurately detect the environment around the vehicle 10.

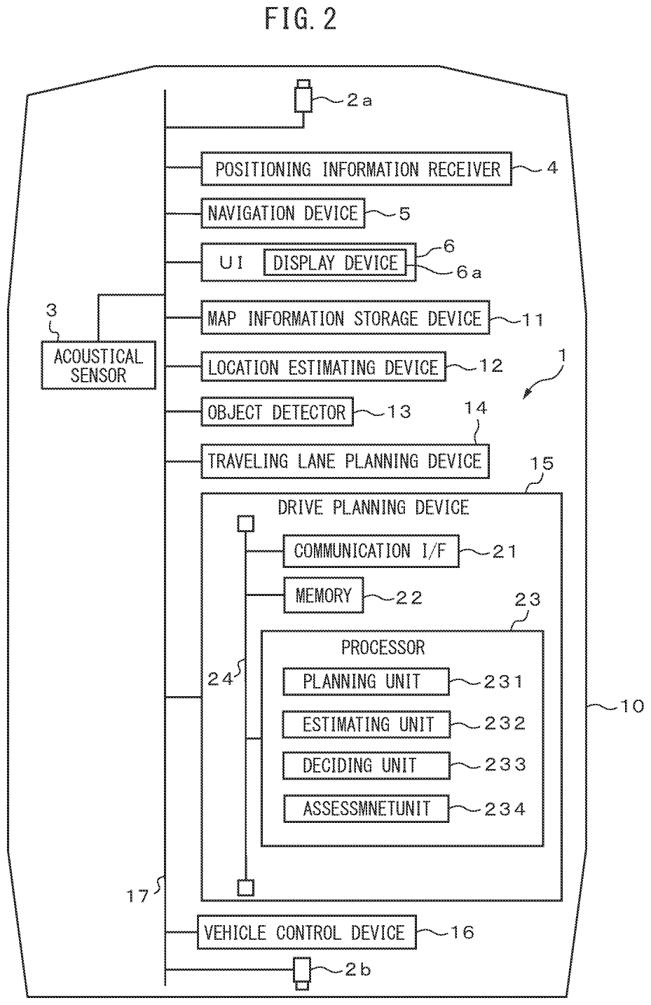

FIG. 2 is a general schematic drawing of the vehicle in which the vehicle control system 1 having the drive planning device 15 of the present embodiment is mounted. The vehicle 10 has a front camera 2a and a rear camera 2b, the acoustical sensor 3, a positioning information receiver 4, a navigation device 5, a user interface (UI) 6, a map information storage device 11, a location estimating device 12, an object detector 13, a travelling lane planning device 14, the drive planning device 15 and a vehicle control device 16, and the like. In addition, the vehicle 10 may have a ranging sensor (not shown) for measuring the distance of objects around the vehicle 10, such as a LiDAR sensor. The vehicle control system 1 has at least the acoustical sensor 3 and the drive planning device 15.

The front camera 2a and the rear camera 2b, the acoustical sensor 3, the positioning information receiver 4, the navigation device 5, UI 6, the map information storage device 11, the location estimating device 12, the object detector 13, the travelling lane planning device 14, the drive planning device 15 and the vehicle control device 16, are communicatively connected via an in-vehicle network 17 conforming to standards such as a controller area network. The front camera 2a and the rear camera 2b are an exemplary imaging units mounted in the vehicle 10. The front camera 2a is mounted to the vehicle 10 directed toward the front of the vehicle 10. The front camera 2a captures, for example, a camera image in which the environment of a predetermined region ahead of the vehicle 10 is shown, at a predetermined cycle. The rear camera 2b is mounted to the vehicle 10 directed toward the back of the vehicle 10. The rear camera 2b captures, for example, a camera image in which the environment of a predetermined region back of the vehicle 10 is shown, at a predetermined cycle. The camera image can show the road in the predetermined region ahead and back of the vehicle 10, and road features such as lane marking lines on the road surface and the other vehicles. Each of the front camera 2a and the rear camera 2b has a 2D detector composed of an array of photoelectric conversion elements with visible light sensitivity, such as a CCD or C-MOS, and an imaging optical system that forms an image of the captured region on the 2D detector.

Each time a camera image is captured, each of the front camera 2a and the rear camera 2b output the camera image and the camera image captured time at which the camera image was captured, through the in-vehicle network 17 to the location estimating device 12 and object detector 13. The camera image is also used for processing at the location estimating device 12 to estimate the location of the vehicle 10. At the object detector 13, the camera image is used for processing to detect other objects surrounding the vehicle 10.

The acoustical sensor 3 inputs the sound around the vehicle 10 to generate the acoustic signal. The acoustical sensor 3 outputs the acoustic signal to the drive planning device 15, etc. via the in-vehicle network 17. As the acoustical sensor 3, for example, a stereo microphone can be used. Sound has a characteristic (diffraction) whereby it travels around any obstacle. Therefore, the acoustical sensor 3, compared to the front camera 2a and the rear camera 2b or a LiDAR sensor, there are fewer blind spots where it is difficult to detect another vehicle. In some embodiments, the acoustical sensor 3 is at a location that facilitates detection of ambient noise around the vehicle 10.

In some embodiments, the acoustical sensor 3 is arranged in the vehicle 10 so as to acquire the left and right sounds relative to the traveling direction of the vehicle 10. The acoustical sensor 3 inputs the left and right and right sounds for the traveling direction of the vehicle 10 to generate the left and right acoustic signals, respectively. In some embodiments, the acoustical sensor 3 is disposed in the vehicle compartment from the viewpoint of protecting the acoustical sensor 3 from an external environment.

The positioning information receiver 4 outputs positioning information that represents the current location of the vehicle 10. The positioning information receiver 4 may be a GNSS receiver, for example. The positioning information receiver 4 outputs positioning information and the positioning information acquisition time at which the positioning information has been acquired, to the navigation device 5 and map information storage device 11, etc., each time the positioning information is acquired at a predetermined receiving cycle.

Based on the navigation map information, the destination location of the vehicle 10 input through the UI 6, and positioning information representing the current location of the vehicle 10 input from the positioning information receiver 4, the navigation device 5 generates a navigation route from the current location to the destination location of the vehicle 10. The navigation route includes information about positions such as right turn, left turn, confluence, branching, etc. When the destination location has been newly set or the current location of the vehicle 10 has exited the navigation route, the navigation device 5 generates a new navigation route for the vehicle 10. Every time a navigation route is generated, the navigation device 5 outputs the navigation route to the location estimating device 12 and the traveling lane planning device 14, etc., via the in-vehicle network 17.

The UI 6 is an example of the notification unit. The UI 6, controlled by the navigation device 5, the drive planning device 15 and the vehicle control device 16, etc., notifies the driver of the vehicle 10 traveling information. The traveling information of the vehicle 10 includes information relating to the current location of the vehicle and the current and future route of the vehicle, such as the navigation route. The UI 6 has a display device 6a such as a liquid crystal display or touch panel, for display of the traveling information. The UI 6 may also have an acoustic output device (not shown) to notify the driver of traveling information. The UI 6 also generates an operation signal in response to operation of the vehicle 10 by the driver. The operation information may be, for example, a destination location, transit points, vehicle speed or other control information of the vehicle 10. The UI 6 also has a touch panel or operating button, for example, as an input device for inputting operation information from the driver to the vehicle 10. The UI 6 outputs the input operation information to the navigation device 5 and the vehicle control device 16, etc., via the in-vehicle network 17.

The map information storage device 11 stores wide-area map information for a relatively wide area (an area of 10 km² to 30 km², for example) that includes the current location of the vehicle 10. In some embodiments, the map information has high precision map information including three-dimensional information for the road surface, information on the types and locations of structures and road features such as road lane marking lines, and the legal speed limit for the road.

The map information storage device 11 receives the wide-area map information from an external server via a base station, by wireless communication through a wireless communication device (not shown) mounted in the vehicle 10, in relation to the current location of the vehicle 10, and stores it in the storage device. Each time positioning information is input from the positioning information receiver 4, the map information storage device 11 refers to the stored wide-area map information and outputs map information for a relatively narrow area including the current location represented by the positioning information (for example, an area of 100 m₂ to 10 km₂), through the in-vehicle network 17 to the location estimating device 12, object detector 13, traveling lane planning device 14, drive planning device 15 and vehicle control device 16, etc.

The location estimating device 12 estimates the location of the vehicle 10 at the camera image captured time, based on the road features surrounding the vehicle 10 represented in the camera image taken by the front camera 2a. For example, the location estimating device 12 compares lane marking lines identified in the camera image with lane marking lines represented in the map information input from the map information storage device 11, and determines the estimated location and estimated declination of the vehicle 10 at the camera image capture time.

The location estimating device 12 has a classifier trained to input camera images and identify lane marking lines. The location estimating device 12 inputs the camera image to the classifier to identify the area of the lane marking line represented in the camera image and determine the reliability (confidence) of the lane marking line identified by the classifier (e.g., real number between 0 and 1).

The location estimating device 12 estimates the road traveling lane where the vehicle 10 is located, based on the lane marking lines represented in the map information and on the estimated location and estimated declination of the vehicle 10. Each time the estimated location, estimated declination and traveling lane of the vehicle 10 are determined at the camera image captured time, the location estimating device 12 outputs the estimated information to the object detector 13, traveling lane planning device 14, drive planning device 15 and vehicle control device 16, etc. The estimated information may also include areas of the lane marking line represented in the camera image and the reliability of the lane marking line identified by the classifier.

Further, the location estimating device 12 calculates information representing the position of the nearest lane marking line relative to the vehicle 10. When two lane marking lines on the left and right sides are detected relative to the traveling direction of the vehicle 10, the location estimating device 12 outputs information representing the respective position of the two lane marking lines relative to the vehicle 10 to the drive planning device 15. Further, when only one of the left and right lanes marking lines is detected relative to the traveling direction of the vehicle 10, the location estimating device 12 outputs information representing the position of the detected one lane marking line to the drive planning device 15. Further, when the lane marking line is not detected within a predetermined area from the vehicle 10, the location estimating device 12 outputs information representing that the position of the lane marking line is not detected to the drive planning device 15.

The object detector 13 detects other objects around the vehicle 10 as well as their types, based on the camera image captured by the front camera 2a and the rear camera 2b.

The object detector 13 has a classifier trained to input camera images and detect other objects. The location estimating device 12 inputs the camera image to the classifier to identify the area of the other object represented in the camera image and reliability of the other object identified by the classifier (e.g., real number between 0 and 1).

The other objects also include other vehicles traveling around the vehicle 10. The object detector 13 also tracks the other object to be detected and calculates the trajectory of the other object being tracked. In addition, the object detector 13 identifies the traveling lane in which the other object is traveling, based on the lane marking lines represented in the map information and the location of the object. The object detector 13 outputs object detection information which includes information representing the type of other objects that were detected, information indicating their locations, and also information indicating their traveling lanes, to the traveling lane planning device 14, drive planning device 15 and vehicle control device 16, etc. via the in-vehicle network 17. The object detection information may include the reliability of the other object identified by the classifier.

The object detector 13 may not be able to accurately detect another vehicle based on the camera images captured by the front camera 2a and the rear camera 2b when the position of another vehicle relative to the vehicle 10 is one where it is difficult to detect another vehicle. For example, the right rear and left rear of the vehicle 10 may be a position at which it is difficult for the object detector 13 to detect another vehicle.

At a traveling lane-planning generation time set in a predetermined cycle, the traveling lane planning device 14 selects a traffic lane on the road on which the vehicle 10 is traveling, within the nearest driving zone (for example, 10 km) selected from the navigation route, based on the map information, the navigation route and surrounding environment information and the current location of the vehicle 10, and generates a traveling lane plan representing the scheduled traveling lane for traveling of the vehicle 10. For example, the traveling lane planning device 14 generates a traveling lane plan for the vehicle 10 to travel on a traffic lane other than a passing traffic lane. Each time a traveling lane plan is generated, the traveling lane planning device 14 outputs the traveling lane plan to the drive planning device 15.

The drive planning device 15 carries out planning processing, estimating processing, deciding processing, and assessment processing. For this purpose, the drive planning device 15 has a communication interface (IF) 21, a memory 22 and a processor 23. The communication interface 21, memory 22 and processor 23 are connected via signal wires 24. The communication interface 21 has an interface circuit to connect the drive planning device 15 with the in-vehicle network 17. The drive planning device 15 is an exemplary the vehicle control device.

The memory 22 is an example of a storage unit, and it has a volatile semiconductor memory and a non-volatile semiconductor memory, for example. The memory 22 stores application computer programs and various data to be used for information processing carried out by the processor 23.

All or some of the functions of the drive planning device 15 are functional modules implemented, for example, by a computer program executed by the processor 23. The processor 23 has a planning unit 231, an estimating unit 232, a deciding unit 233, and an assessment unit 234. Alternatively, the functional module of the processor 23 may be a dedicated arithmetic circuit provided in the processor 23. The processor 23 includes one or more CPUs (Central Processing Unit) and its peripheral circuitries. The processor 23 may further include other operational circuitry, such as a logic unit, a numerical unit, or a graphic processing unit.

At a driving plan generation time set with a predetermined cycle, the planning unit 231 carries out driving plan processing in which it generates a driving plan representing the scheduled traveling trajectory of the vehicle 10 up until a predetermined time (for example, 5 seconds), based on the traveling lane plan, the map information, the current location of the vehicle 10, the surrounding environment information and the vehicle status information. The driving plan is represented as a combination of the target location of the vehicle 10 and the target vehicle speed at the target location, at each time from the current time until the predetermined time. In some embodiments, the cycle in which the driving plan is generated is shorter than the cycle in which the traveling lane plan is generated. The drive planning device 15 generates a driving plan to maintain a spacing of at least a predetermined distance between the vehicle 10 and other vehicles.

The planning unit 231 generates the driving plan based on the camera images captured by the front camera 2a and the rear camera 2b. On the other hand, the acoustical sensor 3 is used to detect the warning sound emitted by another vehicle but is not usually used to generate the driving plan of the vehicle 10.

The drive planning device 15 outputs the driving plan to the vehicle control device 16 for each driving plan generated. Other operations of the drive planning device 15 will be described later.

The vehicle control device 16 controls each unit of the vehicle 10 based on the current location of the vehicle 10 and the vehicle speed and yaw rate, as well as on the driving plan generated by the drive planning device 15. For example, the vehicle control device 16 determines the steering angle, acceleration and angular acceleration of the vehicle 10 according to the driving plan and the speed and yaw rate of the vehicle 10, and sets the amount of steering, and the accelerator or brake level so as to match that steering angle, accelerator level and angular acceleration. The vehicle control device 16 also outputs a control signal corresponding to a set steering amount, to an actuator (not shown) that controls the steering wheel for the vehicle 10, via the in-vehicle network 17. The vehicle control device 16 also outputs a control signal corresponding to set accelerator level, to a drive unit (engine or motor) via the in-vehicle network 17. Alternatively, the vehicle control device 16 may output a control signal corresponding to a set brake level to the brake (not shown) of the vehicle 10, via the in-vehicle network 17.

The map information storage device 11, location estimating device 12, object detector 13, travelling lane planning device 14, drive planning device 15, and vehicle control device 16, for example, an electronic control unit (ECU). For FIG. 2, the map information storage device 11, location estimating device 12, object detector 13, traveling lane planning device 14, drive planning device 15, and vehicle control device 16, were explained as separate devices, but all or some of them may be constructed in a single device.

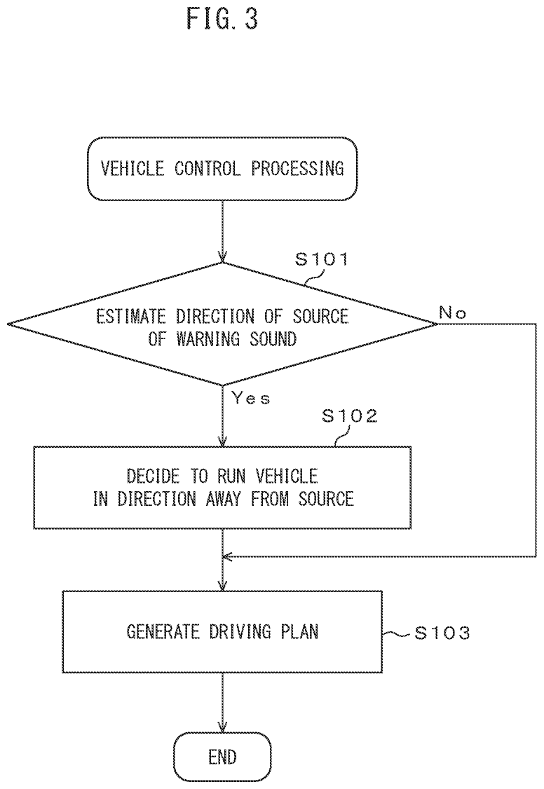

FIG. 3 is an example of an operation flow chart for vehicle control processing for the drive planning device 15 according to the present embodiment. The vehicle control processing by the drive planning device 15 will now be explained with reference to FIG. 3. The drive planning device 15 carries out the vehicle control processing according to the operation flow chart shown in FIG. 3, at a vehicle control time having a predetermined cycle. The period at which the vehicle control processing is carried out may be, for example, 1 to 5 seconds.

First, the estimating unit 232 determines whether a direction of a source of a warning sound generated by another vehicle relative to the vehicle 10 based on an acoustic signal acquired by the acoustical sensor 3 is estimated (step S101). The estimating unit 232 has a classifier trained to input the left and right the acoustic signal acquired by the acoustical sensor 3 to classify the warning sound generated by another vehicle and to identify the direction of the source of the warning sound relative to the vehicle 10. The classifier identifies whether the direction of the source of the warning sound is forward, right, left, or backward direction to the travelling direction of the vehicle 10. The estimating unit 232 inputs the acoustic signal acquired from the acoustical sensor 3 into the classifier to estimate the direction of the source of the warning sound relative to the vehicle 10 upon detection of the warning sound generated by another vehicle.

The classifier is, for example, a convolutional neural network (CNN) having a plurality of layers connected in series from an input side to an output side. The acoustic signal including the warning sound of vehicle is input to the CNN as the teacher data and the CNN is trained. The CNN performs as a classifier by identifying the warning sound of the vehicle and the direction of the source of the warning sound. Another machine learning model may be used as the classifier.

Further, the estimating unit 232 compares the frequency, the amplitude and waveform of the acoustic signal acquired by the acoustical sensor 3 with the frequency, the amplitude and waveform of the reference warning sound and obtains the degree of similarity between them. The estimating unit 232 determines that a warning sound is detected when the degree of similarity is at or above a predetermined degree of similarity. When the warning sound is detected, the estimating unit 232 may compare the amplitudes of the left and right acoustic signals acquired by the acoustical sensor 3 and estimate the direction of the source of the warning sound relative to the vehicle 10 as one of the sides indicating a greater amplitude. When the amplitudes of the left and right acoustic signals acquired by the acoustical sensor 3 are the same, the estimating unit 232 estimates that the direction of the source of the warning sound relative to the vehicle 10 as the traveling direction of the vehicle 10 or a direction opposite to the traveling direction of the vehicle 10.

When the direction of the source of the warning sound relative to the vehicle 10 is estimated (step S101—Yes), the deciding unit 233 decides to drive the vehicle 10 in a direction perpendicular to the current traveling direction of the vehicle 10 and away from the source of the warning sound (step S102). The deciding unit 233 decides the direction away from the source of the warning sound based on the direction of the source of the warning sound. The deciding unit 233 notifies the planning unit 231 of a request to drive the vehicle 10 in a direction perpendicular to the current traveling direction of the vehicle 10 and away from the source of the warning sound.

The deciding unit 233 decides to move the vehicle 10 to the left relative to the traveling direction when the source of the warning sound is on the right relative to the traveling direction of the vehicle 10. The deciding unit 233 decides to move the vehicle 10 to the right relative to the traveling direction when the source of the warning sound is on the left relative to the traveling direction of the vehicle 10. The deciding unit 233 decides to decelerate the vehicle 10 and move the vehicle 10 to the right or left relative to the traveling direction when the source of the warning sound is forward relative to the traveling direction of the vehicle 10. The deciding unit 233 decides to accelerate the vehicle 10 and move the vehicle 10 to the right or left relative to the traveling direction when the source of the warning sound is backward relative to the traveling direction of the vehicle 10.

Moving the vehicle 10 to the right or left relative to the traveling direction is an example of moving in the direction perpendicular to the current traveling direction of the vehicle 10.

The planning unit 231 generates a driving plan that moves the vehicle 10 in a direction perpendicular to the current traveling direction of the vehicle 10 and away from the source of the warning sound (step S103), and the series of processing steps is complete. The vehicle control device 16 drives the vehicle 10 in a direction perpendicular to the current traveling direction of the vehicle 10 and away from the source of the warning sound based on the driving plan.

On the other hand, when the direction of the source of the warning sound relative to the vehicle 10 is not estimated (step S101—No), the planning unit 231 generates a driving plan based on the environment, etc. around the vehicle 10 detected using the front camera 2a and the rear camera 2b, and the series of processing steps is complete.

Further, the vehicle control processing by the drive planning device 15 will now be explained with reference to FIG. 1 and FIG. 4 to FIG. 7.

In the embodiment shown in FIG. 1A, the vehicle 10 is traveling in the traffic lane 51 of the road 50 having the traffic lanes 51, 52. The vehicle 30 traveling in the traffic lane 52 is approaching vehicle 10 from the right rear of vehicle 10. However, the vehicle 30 is not detected by the vehicle 10, since the position of the vehicle 30 relative to the vehicle 10 is in the blind spot of the rear camera 2b mounted on the vehicle 10. The drive planning device 15 generates a driving plan in which the vehicle 10 moves from the traffic lane 51 to the adjacent traffic lane 52. The vehicle 10 then started moving from the traffic lane 51 to the adjacent traffic lane 52.

As shown in FIG. 1A, the vehicle 30 emitted a warning sound to the vehicle 10 that is about to move in front of the vehicle 30. The drive planning device 15 of the vehicle 10 detects the warning sound generated by the vehicle 30 and estimates the direction of the source relative to the vehicle 10, based on the acoustic signal acquired from the acoustical sensor 3.

The drive planning device 15 of the vehicle 10 detects the warning sound generated by the vehicle 30 based on the acoustic signal acquired from the acoustical sensor 3. The drive planning device 15 also estimates that the source of the warning sound generated by the vehicle 30 is on the left relative to the traveling direction of the vehicle 10.

The drive planning device 15 determines that the vehicle 10 is starting to move from the traffic lane 51 to the adjacent lane 52 and the direction of the source of the warning sound relative to the vehicle 10 coincides with the direction of the moving direction of the vehicle 10.

The drive planning device 15 decides to cancel the vehicle 10 moving between the traffic lanes and cause the vehicle 10 to return to the traffic lane 51. The drive planning device 15 cancels the moving of the vehicle 10 between the traffic lanes and generates a driving plan so as to travel in the traffic lane 51. The drive planning device 15 may cause the vehicle 10 to move away from the source of the warning sound by moving the vehicle 10 back to the traffic lane 51.

As shown in FIG. 1B, the vehicle 10 cancels the lane change and returns to the traffic lane 51 in which the vehicle 10 was traveling until then. The vehicle 30 travels along the traffic lane 52 without approaching the vehicle 10 too much and passes by the vehicle 10.

According to the drive planning device 15, the vehicle 10 can drive safely even when the rear camera 2b used to generate the driving plan cannot accurately detect the environment of the vehicle 10.

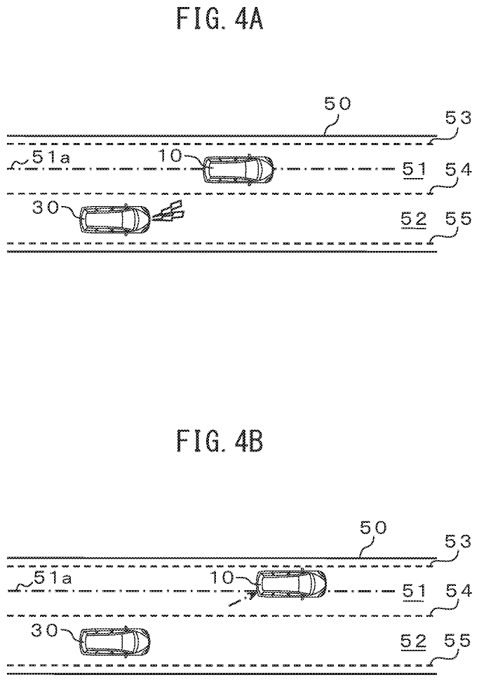

In the embodiment shown in FIG. 4A, the vehicle 10 is traveling in the traffic lane 51 of the road 50 having the traffic lanes 51, 52. The drive planning device 15 has detected the left and right lane making lines 53, 54 which mark the traffic lane 51 in which the vehicle 10 travels.

The drive planning device 15 generates a driving plan such that the vehicle 10 drives in the widthwise central of the traffic lane 51 based on information representing the respective positions of the two lane marking lines 53, 54 relative to the vehicle 10. FIG. 4A shows a centerline 51a indicating the widthwise central of the traffic lane 51.

The vehicle 30 traveling in the traffic lane 52 is approaching the vehicle 10 from the right rear of the vehicle 10. As shown in FIG. 4A, the vehicle 30 emits a warning sound to the vehicle 10.

As a reason why the vehicle 30 emitted the warning sound, it is considered that the vehicle 10 was traveling closer to the traffic lane 52 within the traffic lane 51 because the locations of the lane marking lines 53, 54 detected by the vehicle 10 were incorrect.

The drive planning device 15 detected the warning sound generated by the vehicle 30 based on the acoustic signal acquired by the acoustical sensor 3. The drive planning device 15 also estimates that the source of the warning sound generated by the vehicle 30 is on the right relative to the travelling direction of the vehicle 10.

The drive planning device 15 decides to move the vehicle 10 off the widthwise central of the traffic lane 51 in which the vehicle 10 is traveling, opposite the direction of the source of the warning sound.

The drive planning device 15 generates a driving plan so that the vehicle 10 moves off the centerline 51a of the traffic lane 51, opposite the direction of the source of the warning sound.

As shown in FIG. 4B, the vehicle 10 travels along the lane 51 off the widthwise central of the traffic lane 51, opposite the direction of the source of the warning sound and away from the vehicle 30 which emitted the warning sound. The vehicle 30 travels along the traffic lane 52 without approaching the vehicle 10 too much and passes by the vehicle 10.

As a reason why the locations of the lane marking lines 53, 54 relative to the vehicle 10 were incorrect, it is considered that the lane marking lines 53, 54 were not accurately detected from the camera image captured by the front camera 2a. According to the drive planning device 15, the vehicle 10 can drive safely even when the sensor used to generate the driving plan cannot accurately detect the environment of the vehicle 10.

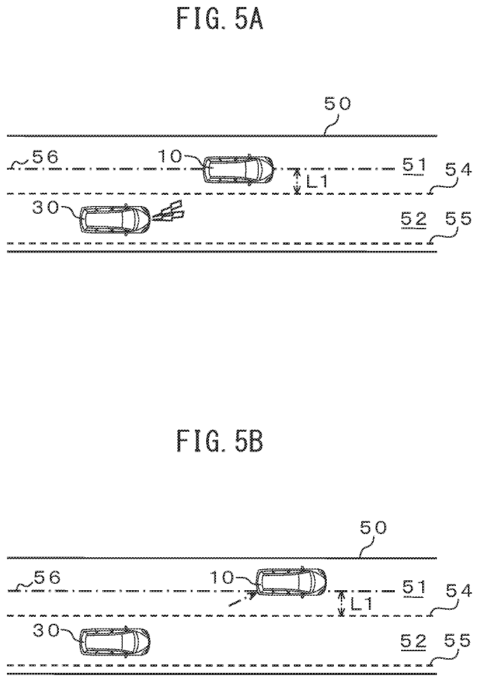

In the embodiment shown in FIG. 5A, the vehicle 10 is traveling in the traffic lane 51 of the road 50 having the traffic lanes 51, 52. The vehicle 10 has detected only the right lane making line 54 which marks the traffic lane 51 in which the vehicle 10 travels.

The drive planning device 15 decides to drive the vehicle 10 in the widthwise central of the traffic lane 51 based on information representing the position of the lane marking line 54 relative to the vehicle 10. The drive planning device 15 generates a driving plan such that the vehicle 10 travels a predetermined distance L1 away from the lane marking line 54. The distance L1 may be equal to half the width (e.g., 3.6 m) of a typical lane. In FIG. 5A, a line 56 is shown indicating a location away from the lane marking line 54 by a predetermined distance L1.

The vehicle 30 traveling in the traffic lane 52 is approaching the vehicle 10 from the right rear of the vehicle 10. As shown in FIG. 5A, the vehicle 30 emits a warning sound to the vehicle 10.

As a reason why the vehicle 30 emitted the warning sound, it is considered that the vehicle 10 was traveling closer to the traffic lane 52 within the traffic lane 51 because the location of the lane marking line 54 detected by the vehicle 10 is incorrect.

The drive planning device 15 detected the warning sound generated by the vehicle 30 based on the acoustic signal acquired by the acoustical sensor 3. The drive planning device 15 also estimates that the source of the warning sound generated by the vehicle 30 is on the right relative to the travelling direction of the vehicle 10.

The drive planning device 15 decides to cause the vehicle 10 to drive at a location further shifted from the location which is apart from the lane marking line 54 by the predetermined distance L1, opposite the direction of the source of the warning sound relative to the vehicle 10.

The drive planning device 15 generates a driving plan such that the vehicle 10 drives at the location further shifted from the location which is apart from the lane marking line 54 by the predetermined distance L1, opposite the direction of the source of the warning sound relative to the vehicle 10.

As shown in FIG. 5B, the vehicle 10 travels along the lane 51 at a location further shifted from the location which is apart from the lane marking line 54 by the predetermined distance L1, opposite the direction of the source of the warning sound relative to the vehicle 10, and away from the vehicle 30 which emitted the warning sound. The vehicle 30 travels along the traffic lane 52 without approaching the vehicle 10 too much and passes by the vehicle 10.

As a reason why the location of the lane marking line 54 relative to the vehicle 10 was incorrect, it is considered that the lane marking line 54 was not accurately detected from the camera image captured by the front camera 2a. According to the drive planning device 15, the vehicle 10 can drive safely even when the sensor used to generate the driving plan cannot accurately detect the environment of the vehicle 10.

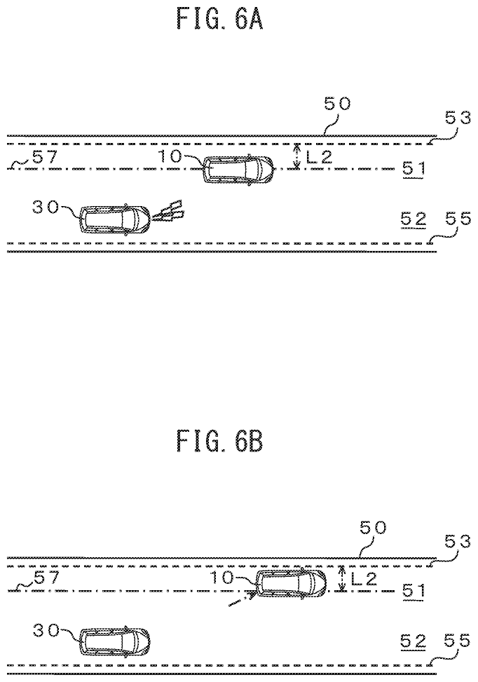

In the embodiment shown in FIG. 6A, the vehicle 10 is traveling in the traffic lane 51 of the road 50 having the traffic lanes 51, 52. The vehicle 10 has detected only the left lane making line 53 which marks the traffic lane 51 in which the vehicle 10 travels.

The drive planning device 15 decides to drive the vehicle 10 in the widthwise central of the traffic lane 51 based on information representing the position of the lane marking line 53 relative to the vehicle 10. The drive planning device 15 generates a driving plan such that the vehicle 10 travels a predetermined distance L2 away from the lane marking line 53. The distance L2 may be equal to half the width (e.g., 3.6 m) of a typical lane. In FIG. 6A, a line 57 is shown indicating a location away from the lane marking line 53 by a predetermined distance L2.

The vehicle 30 traveling in the traffic lane 52 is approaching the vehicle 10 from the right rear of the vehicle 10. As shown in FIG. 6A, the vehicle 30 emits a warning sound to the vehicle 10.

As a reason why the vehicle 30 emitted the warning sound, it is considered that the vehicle 10 was traveling closer to the traffic lane 52 within the traffic lane 51 because the location of the lane marking line 53 detected by the vehicle 10 is incorrect.

The drive planning device 15 detected the warning sound generated by the vehicle 30 based on the acoustic signal acquired by the acoustical sensor 3. The drive planning device 15 also estimates that the source of the warning sound generated by the vehicle 30 is on the right relative to the travelling direction of the vehicle 10.

The drive planning device 15 decides to cause the vehicle 10 to drive at a location further shifted from the location which is apart from the lane marking line 53 by the predetermined distance L2, opposite the direction of the source of the warning sound relative to the vehicle 10.

The drive planning device 15 generates a driving plan such that the vehicle 10 drives at a location further shifted from the location which is apart from the lane marking line 53 by the predetermined distance L2, opposite the direction of the source of the warning sound relative to the vehicle 10.

As shown in FIG. 6B, the vehicle 10 travels along the lane 51 at a location further shifted from the location which is apart from the lane marking line 53 by the predetermined distance L2, opposite the direction of the source of the warning sound relative to the vehicle 10, and away from the vehicle 30 which emitted the warning sound. The vehicle 30 travels along the traffic lane 52 without approaching the vehicle 10 too much and passes by the vehicle 10.

As a reason why the location of the lane marking line 53 relative to the vehicle 10 was incorrect, it is considered that the lane marking line 53 was not accurately detected from the camera image captured by the front camera 2a. According to the drive planning device 15, the vehicle 10 can drive safely even when the sensor used to generate the driving plan cannot accurately detect the environment of the vehicle 10.

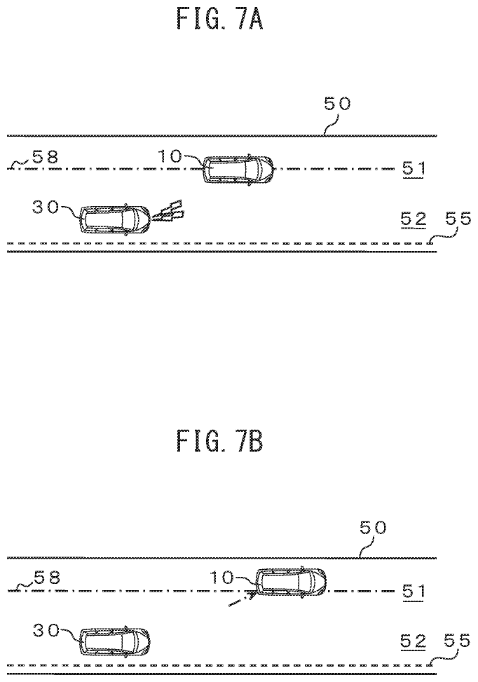

In the embodiment shown in FIG. 7A, the vehicle 10 is traveling in the traffic lane 51 of the road 50 having the traffic lanes 51, 52. The vehicle 10 has not detected any lane making lines which mark the traffic lane 51 in which the vehicle 10 travels.

The drive planning device 15 decides to cause the vehicle 10 to travel in the widthwise central of the traffic lane 51 in which the vehicle 10 is traveling, based on the current location of the vehicle 10 and the map information. The drive planning device 15 estimates that the lane in which the vehicle 10 is traveling is the traffic lane 51 and generates a driving plan to travel in the widthwise central of the traffic lane 51 in the map information. In FIG. 7 A, a centerline 58 is shown indicating the widthwise central of the traffic lane 51.

The vehicle 30 traveling in the traffic lane 52 is approaching the vehicle 10 from the right rear of the vehicle 10. As shown in FIG. 7A, the vehicle 30 emits a warning sound to the vehicle 10.

As a reason why the vehicle 30 emitted the warning sound, it is considered that the vehicle 10 was traveling closer to the traffic lane 52 within the traffic lane 51 because the actual location of the traffic lane 51 is different from the estimated location from the map information.

The drive planning device 15 detected the warning sound generated by the vehicle 30 based on the acoustic signal acquired by the acoustical sensor 3. The drive planning device 15 also estimates that the source of the warning sound generated by the vehicle 30 is on the right relative to the travelling direction of the vehicle 10.

The drive planning device 15 decides to drive the vehicle 10 at a location further shifted from the widthwise central of the traffic lane 51 in the map information, opposite the direction of the source of the warning sound relative to the vehicle 10.

The drive planning device 15 generates a driving plan such that the vehicle 10 drives at a location further shifted from the widthwise central of the traffic lane 51 in the map information, opposite the direction of the source of the warning sound relative to the vehicle 10.

As shown in FIG. 7B, the vehicle 10 travels along the lane 51 at a location further shifted from the widthwise central of the traffic lane 51 in the map information, opposite the direction of the source of the warning sound relative to the vehicle 10, and away from the vehicle 30 which emitted the warning sound. The vehicle 30 travels along the traffic lane 52 without approaching the vehicle 10 too much and passes by the vehicle 10.

According to the drive planning device 15, the vehicle 10 can drive safely even when the front camera 2a used to generate the driving plan cannot accurately detect the environment of the vehicle 10.

As described above, the drive planning device can drive the host vehicle so as to avoid the host vehicle approaching another vehicle when the warning sound of another vehicle is detected. This allows the host vehicle to travel safely even when a sensor used to generate the driving plan cannot accurately detect the environment around the host vehicle.

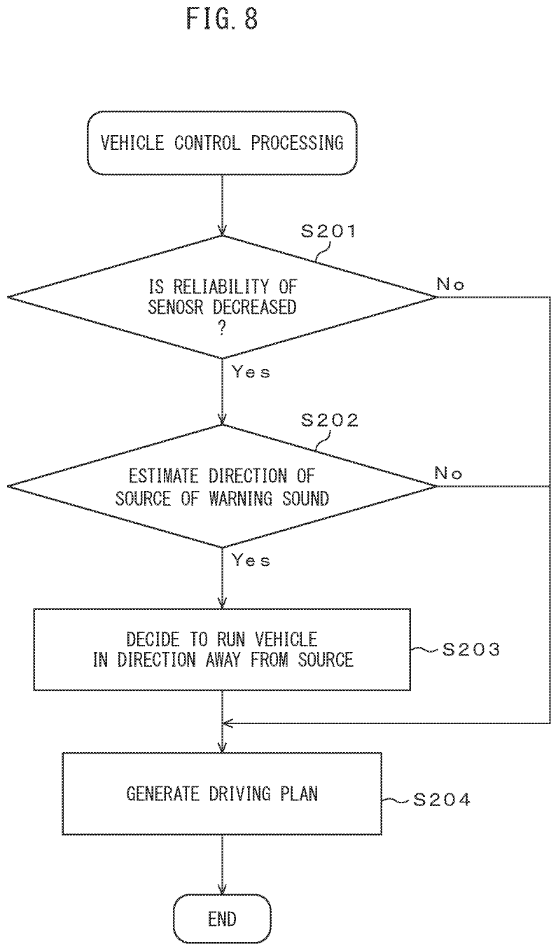

Next, a modified embodiment of the drive planning device 15 of the present embodiment described above will be explained below with reference to FIG. 8. FIG. 8 is another example of an operation flow chart for vehicle control processing for the drive planning device 15 according to the present embodiment.

In the vehicle control processing of this modified embodiment, a step S201 is added, which is different from the above-described embodiment. The processing of step S202 to step S204 is similar to the step S101 to step S103 described above.

In the vehicle control processing of this modified embodiment, first, the assessment unit 234 determines whether the reliability of detecting an environment around the vehicle 10 by another sensor other than the acoustical sensor 3 is at or below a predetermined reference reliability (step S201). The front camera 2a and the rear camera 2b are exemplary sensors other than the acoustical sensor 3.

The assessment unit 234 determines that the reliability is decreased when a state where the reliability of the lane marking line represented in the camera image is at or below a first reference reliability (for example, 0.3 to 0.6) continues for a first period.

In addition, the assessment unit 234 determines that the reliability is decreased when a state where the reliability of type of an object is at or below a second reference reliability (for example, 0.3 to 0.6) continues for a second period.

For example, the camera image becomes blurred when raindrops adhere to the light receiving portion of the front camera 2a or the rear camera 2b (e.g., lenses, etc.). In addition, the presence of the raindrops between the front camera 2a or the rear camera 2b, and the road features, etc. represented in the camera image becomes blurred. When the camera image becomes blurred, it is difficult to detect the road features such as lane marking line from the camera image. In addition, when the front camera 2a or the rear camera 2b fails, the assessment unit 234 may determine that the reliability of detecting the environment around the vehicle 10 by the front camera 2a or the rear camera 2b is decreased.

Further, when a LiDAR sensor is mounted as a sensor, and the raindrops adhere to the portion for emitting and receiving the laser, or the emitted laser is scattered by the raindrop, measuring the distance between the vehicle 10 and other objects may not be performed accurately since the laser is not normally received.

When it is determined that the reliability of the sensor is decreased (step S201—Yes), the estimating unit 232 determines whether a direction of a source of a warning sound generated by another vehicle relative to the vehicle 10 based on an acoustic signal acquired from the acoustical sensor 3 is estimated (step S201).

On the other hand, when it is determined that the reliability of the sensor is not decreased (step S201—No), the planning unit 231 generates a driving plan based on the environment, etc. around the vehicle 10 detected using the front camera 2a and the rear camera 2b, and the series of processing steps is complete. The processing in the other steps is the same as in the above-described embodiment.

Another vehicle may not emit the warning sound only when another vehicle is about to approach the vehicle 10. Causing the vehicle 10 to avoid approaching another vehicle each time another vehicle emits the warning sound result in extra operation.

Therefore, in this modified embodiment, the drive planning device 15 causes the vehicle 10 to avoid approaching another vehicle when the reliability of the front camera 2a or the rear camera 2b in detecting the environment around the vehicle 10 is decreased and the warning sound of another vehicle is detected.

When the reliability of the front camera 2a or the rear camera 2b in detecting the environment around the vehicle 10 is normal, a safe driving plan may be generated based on the information detected by the front camera 2a or the rear camera 2b.

On the other hand, when the reliability of the front camera 2a or the rear camera 2b in detecting the environment around the vehicle 10 is decreased, the drive planning device 15 can generate a safe driving plan by detecting the warning sound of another vehicle.

The vehicle control device, a computer program for controlling vehicle, and a method for controlling vehicle according to the embodiments described in the present disclosure may incorporate appropriate modifications that still fall within the gist of the disclosure. Moreover, the technical scope of the disclosure is not limited to these embodiments, and includes the present disclosure and its equivalents as laid out in the Claims.

1. A vehicle control device comprising:
a processor configured to
estimate a direction of a source of a warning sound generated by another vehicle relative to the host vehicle based on an acoustic signal acquired by an acoustical sensor, and
decide to drive the host vehicle in a direction perpendicular to a current traveling direction of the host vehicle and away from the source of the warning sound, when the direction of the source of the warning sound relative to the host vehicle is estimated.

2. The vehicle control device according to claim 1, wherein the processor is further configured to
determine whether a reliability of detecting an environment around the host vehicle by another sensor other than the acoustical sensor is at or below a predetermined reference reliability, and
decide to drive the host vehicle in the direction perpendicular to the current traveling direction of the host vehicle and away from the source of the warning sound, when the reliability is at or below the predetermined reference reliability and the direction of the source of the warning sound relative to the host vehicle is estimated.

3. The vehicle control device according to claim 1, wherein the processor is further configured to cause the host vehicle to travel back to the travelling lane when the host vehicle is starting to move from the travelling lane to the adjacent lane and the direction of the source of the warning sound relative to the host vehicle coincides with the direction of the moving direction of the host vehicle.

4. The vehicle control device according to claim 1, wherein the processor is further configured to
decide to drive the host vehicle in the central of the traveling lane in which the host vehicle is traveling, when the direction of the source of the warning sound relative to the host vehicle is not estimated, and
decide to drive the host vehicle off the central of the traveling lane in which the host vehicle is traveling on the opposite side from the direction of the source of the warning sound relative to the host vehicle.

5. A computer-readable, non-transitory storage medium storing a computer program for controlling a vehicle, which causes a processor to execute a process, the process comprising:
estimating a direction of a source of a warning sound generated by another vehicle relative to the host vehicle based on an acoustic signal acquired by an acoustical sensor; and
deciding to drive the host vehicle in a direction perpendicular to a current traveling direction of the host vehicle and away from the source of the warning sound, when the direction of the warning sound relative to the host vehicle is estimated.

6. A method for controlling a vehicle carried out by a vehicle control device, the method comprising:
estimating a direction of a source of a warning sound generated by another vehicle relative to the host vehicle based on an acoustic signal acquired by an acoustical sensor; and
deciding to drive the host vehicle in a direction perpendicular to a current traveling direction of the host vehicle and away from the source of the warning sound, when the direction of the warning sound relative to the host vehicle is estimated.
